(19) United States
(12) Patent Application Publication
(10) Pub. No.: US 2019/0327774 A1
(43) Pub. Date: Oct. 24, 2019

(54) METHOD AND DEVICE FOR AUTOMATIC PAIRING

(71) Applicant: SZ DJI OSMO TECHNOLOGY CO., LTD., Shenzhen (CN)

(72) Inventors: Tianhang MA, Shenzhen (CN); Xin YAN, Shenzhen (CN)

(21) Appl. No.: 16/459,110

(22) Filed: Jul. 1, 2019

Related U.S. Application Data
(63) Continuation of application No. PCT/CN2016/113549, filed on Dec. 30, 2016.

(51) Int. Cl. H04W 76/14

(52) U.S. Cl. CPC H04W 76/14; H04W 8/005

(57) ABSTRACT

Method and device for an automatic pairing are provided. The method includes identifying the second device using a first communication method and establishing a pairing relationship with the identified second device using a second communication method. The second communication method has a larger communication range than the first communication method.

### CROSS-REFERENCE TO RELATED APPLICATION

This application is a continuation application of International Application No. PCT/CN2016/113549, filed on Dec. 30, 2016, the entire content of which is incorporated herein by reference.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of communication and, more specifically, to a method and a device for automatic pairing.

### BACKGROUND

Current mobile terminals (e.g., mobile phones, tablets, etc.) include a variety of features including image capturing, etc. As an auxiliary device to the mobile terminals, a handheld gimbal may provide a stable image capturing condition for the mobile terminals and may also provide a variety of control functions for the mobile terminals to facilitate user operations. To control the mobile terminal through the handheld gimbal, a reliable communication connection needs to be established between the handheld gimbal and the mobile terminal. Conventional communication connections between the handheld gimbal and the mobile terminal are mainly established a wired connection and a wireless connection.

However, the wired connection requires the use of a wire to connect the mobile terminal and the gimbal, which can be a cumbersome task. The wire may get tangled easily and bring inconvenience to the user. Further, the wireless connection between the mobile terminal and the gimbal also requires a complicated configuration and pairing process. For example, the user needs to adjust the mobile terminal and the gimbal to a pairable state respectively, then connect the mobile terminal with the gimbal, and then open an application on the mobile terminal that controls the gimbal to begin the interaction between the mobile terminal and the gimbal. This series of steps is cumbersome and time consuming, and not every user is able to successfully pair the mobile terminal with the gimbal.

### SUMMARY

One aspect of the present disclosure provides a method for an automatic pairing of a first device with a second device. The method includes identifying the second device using a first communication method and establishing a pairing relationship with the identified second device using a second communication method. The second communication method has a larger communication range than the first communication method.

Another aspect of the present disclosure provides a first device for automatically pairing with a second device. The first device includes a first communication component configured for a first communication method; a second communication component configured for a second communication method; and a processor. The processor is configured to perform: identifying the second device via the first communication component using the first communication method; and establishing a pairing relationship with the identified second device using the second communication method via the second communication component. The second communication method has a larger communication range than the first communication method.

### BRIEF DESCRIPTION OF THE DRAWINGS

For a more complete understanding of the present disclosure and its advantages, reference is now made to the following description taken in conjunction with the accompanying drawings, in which:

FIG. 1 is a schematic diagram of a handheld gimbal according to an embodiment of the present disclosure;

FIG. 2 is a detailed schematic diagram of a near field communication (NFC) area in a fixed structure of a mobile phone of the handheld gimbal shown in FIG. 1 according to an embodiment of the present disclosure;

FIG. 3 is a schematic diagram illustrating an approximate location of an NFC chip in an NFC-enabled mobile phone according to an embodiment of the present disclosure;

FIG. 4 is a schematic diagram illustrating the mobile phone shown in FIG. 3 being held in the handheld gimbal shown in FIG. 1 according to an embodiment of the present disclosure;

FIG. 5 is a flowchart illustrating a method for automatic pairing performed in a first device according an embodiment of the present disclosure;

FIG. 6 is a block diagram illustrating an example of the first device for performing the method shown in FIG. 5 according to an embodiment of the present disclosure;

FIG. 7 is a flowchart illustrating a method for automatic pairing performed in a second device according to an embodiment of the present disclosure; and

FIG. 8 is a block diagram illustrating an example of the second device for performing the method shown in FIG. 7 according to an embodiment of the present disclosure.

### DETAILED DESCRIPTION OF THE EMBODIMENTS

The exemplary embodiments of the present disclosure will be described below in conjunction with the accompanying drawings, other aspects, advantages and salient features of the present disclosure will be become apparent to those skilled in the art.

In the present disclosure, the terms “include” and “comprise,” as well as derivatives thereof, mean inclusion without limitation.

In the present disclosure, various embodiments are merely used to describe the principle of the present disclosure and should not be construed as limiting the scope of the present disclosure. Further, the following description with reference to the accompanying drawings is provided to assist in a comprehensive understanding of exemplary embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness. Furthermore, throughout the drawings, the same reference numerals are used for the same or similar functions and operations.

Before describing the embodiments of the present disclosure in detail, the meaning of some of the technical terms used in the present disclosure will be explained first.

Near field communication (NFC), which is also called as a short-range wireless communication, is a short-range high frequency wireless communication technology that allows electronic devices to perform contactless point-to-point data transmission to exchange data within a short distance such as 10 cm (3.9 inches). The technology evolved from the contactless Radio Frequency Identification (RFID) technology and was developed by Philips Semiconductors (now NXP Semiconductors), Nokia, and Sony on the basis of RFID and interconnect technologies. NFC is a short-range high frequency radio technology that operates at 13.56 MHz within 10 cm with three transmission rates at 106 Kbit/s, 212 Kbit/s and 424 Kbit/s. At present, NFC has become the ISO/IEC IS 18092 international standard, the EMCA-340 standard and the ETSI TS 102 190 standard, and devices that support NFC can use both the active and passive read modes.

Bluetooth (BT) is a wireless technology standard that allows fixed and portable devices to exchange data over a short distance to form a Personal Area Network (PAN). BT uses Ultra High Frequency (UHF) radio wave to communicate via the 2.4 to 2.85 GHz ISM band. This technology was developed by Ericsson in 1994, and it was originally designed to create a wireless alternative of the RS-232 data cables. BT can connect to multiple devices to overcome synchronization problems.

The present disclosure provides a technical solution that allows a handheld gimbal and a mobile terminal (e.g., a mobile phone, a tablet, etc.) to quickly identify and pair with each other. Various embodiments may allow two devices to mutually determine the presence of each other and the identity of the other device using a first communication method, including a first communication technology having a smaller communication range (e.g., NFC, RFID, etc.), then a second communication method, including a second communication technology having a relatively larger communication range. Higher transmission speed (e.g., Bluetooth, Wi-Fi, etc.) may be used to establish a communication connection or pairing relationship based on the identified information (e.g., an identifier of the other device, the network address, etc.) to facilitate the interactions (e.g., control, data transfer, etc.) between the two devices. Hence, using the first communication technology with a smaller communication range, most of the other devices that may cause interference within the communication range of the second communication technology may be excluded, so the devices that need to be paired may be quickly identified. Subsequently, a communication connection between the two (or more) devices may be established using the second communication technology with larger communication range and higher communication rate.

It should be noted, however, that although in the following embodiments of the present disclosure, the description has been made by taking a handheld gimbal and a mobile terminal as an example, the present disclosure is not limited thereto. In fact, the present disclosure is also applicable to pair between various devices. For example, both devices can be mobile terminals, or both devices can be fixed devices or devices that move relatively infrequently. In fact, the technical solution provided in the present disclosure can be employed between any two or more devices that support two different communication technologies.

Further, although in the following embodiments of the present disclosure, the description is made using the distance as an example of the communication range, the concept of the communication range is not limited thereto. In fact, the present disclosure is also applicable to communication technologies having different communication frequencies, transmission powers, communication rates, etc. For example, the first communication technology may be a communication technology with a narrower communication band, and the second communication technology may be a communication technology with a wider communication band. In this case, using the communication technology with the narrow communication band, relatively fewer connection candidates can be determined in the relatively narrow communication band, so a connection target can be quickly identified, then the second communication technology with the wider communication band may be used to establish a communication connection with higher transmission rate and wider range to enable to pairing between devices.

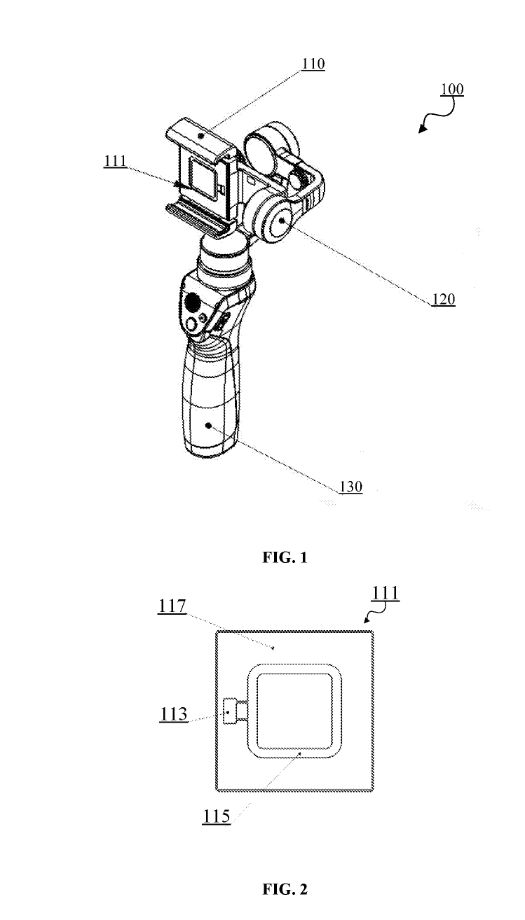

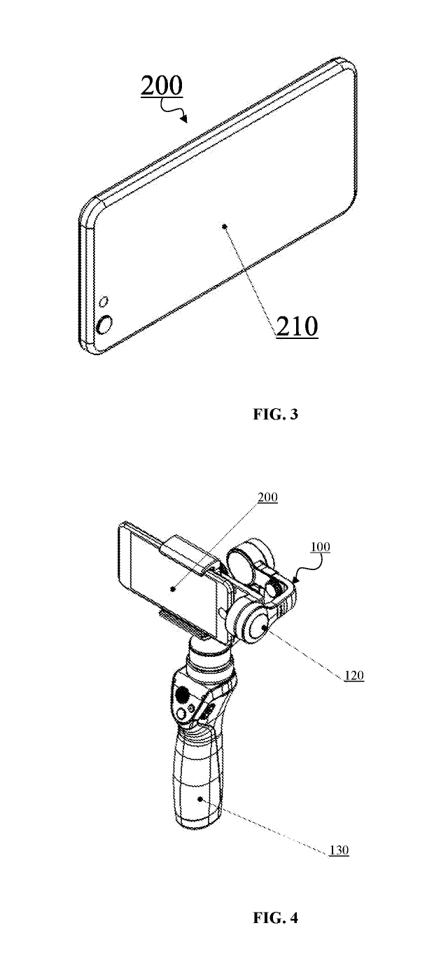

Hereinafter, the first device of the present invention will be described in detail with reference to FIG. 1 and FIG. 2 using a handheld gimbal as an example. At the same time, the second device will be described with reference to FIG. 3 using a mobile phone as an example.

FIG. 1 is a schematic diagram of a handheld gimbal 100 according to an embodiment of the present disclosure. FIG. 2 is a detailed schematic diagram of an NFC area in a fixed structure of a mobile phone of the handheld gimbal 100 shown in FIG. 1 according to an embodiment of the present disclosure.

As shown in FIG. 1, the handheld gimbal 100 may include the following components: a mobile phone fixture 110, a three-axis gimbal 120, and a gimbal handle 130. Further, a control mechanism such as function buttons and a joystick may be disposed on the gimbal handle 130 to interact with a mobile phone 200 using the function buttons, the joystick, etc. when the handheld gimbal 100 establishes a pairing relationship with the mobile phone 200. Furthermore, as shown in FIG. 1, the gimbal handle 130 has a shape that may be suitable for grasping by a human hand, and a function button or the like disposed at a location where a thumb may be easily pressed on it when the gimbal handle 130 is held by hand.

As shown in FIG. 1, the gimbal handle 130 may be connected to and supported by the three-axis gimbal 120, which may be rotatably connected to the gimbal handle 130 and the mobile phone fixture 110. The three-axis gimbal 120 allows the mobile phone fixture 110 to rotate relative to the gimbal handle 130 along three mutually orthogonal axes (e.g., the yaw axis, roll axis, and the pitch axis) so a mobile phone (e.g., the mobile phone 200 to be described below) held in the mobile phone fixture 110 may be freely rotated. Of course, the embodiment of the present disclosure is not limited thereto. In fact, the mobile phone fixture 110 may also be directly connected to the gimbal handle 130 without the three-axis gimbal 120. Further, the gimbal 120 is not limited to a three-axis gimbal, but may be rotated only on one or two axes.

In the embodiment shown in FIG. 1, the mobile phone fixture 110 may be a fixture having a clamping structure for fixing the mobile phone therein in a clamping manner, which may be convenient for a user to use. For example, a plurality of grippers of the clamping structure may be used to fix the mobile phone. Further, although the mobile phone fixing device 110 has a clamping structure in the embodiment shown in FIG. 1, the embodiment of the present disclosure is not limited thereto. In fact, the mobile phone fixture 110 may also be other types of fixtures including, but not limited to, magnetic force, slots, snaps, bonding, and the like. For example, the mobile phone fixture 110 may have a magnet therein, and the mobile phone may include a portion of materials (e.g., iron, cobalt, nickel, etc.) that may be attracted by the magnet such that the mobile phone may be relatively fixed to the mobile phone fixture 110 by magnetic force.

As shown in FIG. 1, the mobile phone fixture 110 may further include an NFC area 111 to provide NFC functionalities. For example, the NFC area 11 may be placed between the grippers of the clamping structure. The NFC area 111 will be described in detail below with reference to FIG. 2. As shown in FIG. 2, the NFC area 111 may include an NFC chip 113, an NFC coil 115, and an NFC pad 117. The NFC chip 113 may be used for processing an NFC signal detected from the NFC coil 115 or a signal to be transmitted through the NFC coil 115. As shown in FIG. 2, the NFC coil 115 may be formed on the NFC pad 117 and may have a substantially square structure. However, the embodiment of the present disclosure is not limited thereto. The NFC coil 115 may have other shapes such as a circle, an ellipse, a rectangle, a triangle, various types of regular or irregular polygons, and the like. Further, the location of the NFC chip 113 is also not limited to an outer side of the NFC coil 115, but may be located in the NFC coil 115 or at other appropriate locations. Furthermore, the NFC chip 113 and the NFC coil 115 are not limited to being on or in the pad 117. In fact, the NFC pad 117 may not be included, so that the NFC chip 113 and the NFC coil 115 may be directly located on the mobile phone fixture 110. Additionally, the NFC chip 113 and the NFC coil 115 may also be located at other locations other than the NFC pad 117, such as on the gimbal handle 130.

It can be understood that a device identification module is not limited to the NFC area 111 and may be other modules such as a RFID module.

Although not shown in FIG. 1, the mobile phone fixture 110 may also include components (e.g., circuit boards, wires, etc. or components that may communicate wirelessly) to facilitate communication between the control buttons on the gimbal handle 130 to communicate with the NFC chip 113. Thus, with the NFC chip 113 and the NFC coil 115, the gimbal handle 130 may establish a communication connection with the mobile phone, such that the gimbal handle 130 may interact with the mobile phone, such as controlling the mobile phone to capture images, display captured photo, and the like.

Next, a schematic diagram of a mobile phone having an NFC function will be described in detail with reference to FIG. 3. FIG. 3 is a schematic diagram illustrating an approximate location of an NFC chip 210 in an NFC-enabled mobile phone 200 according to an embodiment of the present disclosure. As shown in FIG. 3, the NFC-enabled mobile phone 200 may include an NFC chip 210 near its center portion, and the NFC-enabled mobile phone 200 may communicate and interact with other NFC devices through the NFC chip 210. Of course, the present disclosure is not limited thereto. In fact, the NFC chip 210 may be placed at any location of the mobile phone 200. As described above, since the communication range of the NFC technology is generally in the range of 10 cm, in the embodiment of the present disclosure, the NFC chip 210 may be placed at any location of the mobile phone 200 without substantially affecting its normal operation.

FIG. 4 is a schematic diagram illustrating the mobile phone 200 shown in FIG. 3 being held in the handheld gimbal 100 shown in FIG. 1 according to an embodiment of the present disclosure. In general, the handheld gimbal 100 may be considered as a carrier, while the mobile phone 200 may be considered as a load being carried on the handheld gimbal 100. However, the present disclosure is not limited thereto. In fact, the carrier may also be a device other than a handheld gimbal, such as a drone, a tripod, an unmanned vehicle, an unmanned boat or any other device that can carry a load. In addition, the load may also be a device other than a mobile phone, such as a tablet, camera, video camera, probe, sensor, etc. to execute one or more tasks, or any other portable electronic device or information acquisition device.

As shown in FIG. 4, when the mobile phone 200 is clamped in the mobile phone fixing device 110 of the handheld gimbal 100, the NFC chip 210 of the mobile phone 200 may be close to the NFC coil 115 of the handheld gimbal 100 at a distance less than the maximum communication distance required by the NFC technology. Thus, the NFC chip 113 of the handheld gimbal 100 may obtain the identity information transmitted by the NFC chip 210 of the mobile phone 200 through the NFC coil 115, that is, acquiring the identification information.

In one embodiment of the present disclosure, the transmission of the identity information may be active or passive. For example, the NFC chip 210 of the mobile phone 200 may periodically transmit its identity information to indicate its presence to the surrounding NFC devices. In another example, the NFC chip 210 may transmit its own identity information in response to a query (e.g., polling, broadcasting) message from other NFC devices.

When the NFC chip 113 of the handheld gimbal 100 detects the identity information from the mobile phone 200, a Bluetooth module (not shown) of the handheld gimbal 100 can establish a Bluetooth communication connection with the mobile phone 200 based on the identity information of the mobile phone 200, and thereby achieving a quick pairing relationship between the handheld gimbal 100 and the mobile phone 200.

The Bluetooth module of the handheld gimbal 100 may be in a constant working state to find a connectable device. Or, the Bluetooth module of the handheld gimbal 100 may be triggered to start working when the handheld gimbal 100 detects the identity information of the mobile phone 200, so the Bluetooth module may not be activated before the identity information of the connectable mobile phone 200 is acquired, thereby reducing power consumption.

In some embodiments, after the handheld gimbal 100 establishes a pairing relationship with the mobile phone 200, the handheld gimbal 100 may automatically trigger an opening of an operation interface on the mobile phone 200, such as, but not limited to, the operation interface of the camera application. In other embodiments, after the handheld gimbal 100 establishes a pairing relationship with the mobile phone 200, the mobile phone 200 can also automatically open an operation interface thereon, such as, but not limited to, the operation interface of the camera application without the triggering from the handheld gimbal 100.

The structures of the handheld PTZ assembly 100 and the mobile phone 200 according to the embodiments of the present disclosure have been described in detail with reference to FIGS. 1-4. Using the method and device in the embodiments of the present disclosure, a pairing chip (e.g., the NFC chip 113) may be added to the handheld gimbal 100 and the mobile phone 200 may be identified using the pairing chip, then the pairing connection may be quickly established using Bluetooth, and an application may automatically open to start capturing images after the connection is established. The method and device provided in the present disclosure provide a quick, convenient, and stable connection. The technical solution provided in the present disclosure allows the pairing steps of the mobile phone 200 and the handheld gimbal 100 to be simplified to one step by placing the mobile phone 200 on the handheld gimbal 100 to complete the automatic pairing and start capturing images, thereby greatly improving the operation of the handheld gimbal 100 and the user experience.

A method for automatically pairing the first device (e.g., the handheld gimbal 100) and the second device (e.g., the mobile phone 200), and the functional structures of the first device and the second device will be described in detail below according to the embodiments of the present disclosure with reference to FIGS. 5-8.

FIG. 5 is a flowchart illustrating a method 500 for performing an automatic pairing in a first device with a second device performed according an embodiment of the present disclosure. As shown in FIG. 5, the method 500 may include steps S510 and S520. In accordance with the present disclosure, some of the steps of method 500 may be performed separately or in combination, and may be performed in parallel or sequentially, and is not limited to the specific order of operations illustrated in FIG. 5. In some embodiments, method 500 may be performed by the handheld gimbal 100 as shown in FIG. 1.

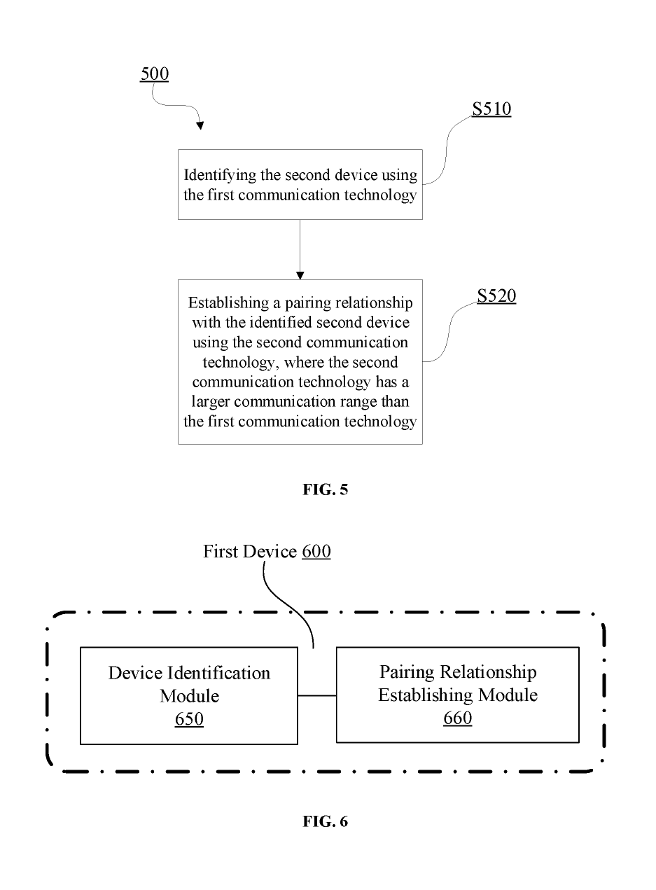

FIG. 6 is a functional block diagram illustrating an example of the first device 600 for performing the automatic pairing according to an embodiment of the present disclosure. As shown in FIG. 6, the first device 600 may include a device identification module 650 and a pairing relationship establishing module 660.

The device identification module 650 may be used to identify a second device 800 using a first communication method including a first communication technology. The device identification module 650 may be a Central Processing Unit (CPU), a Digital Signal Processor (DSP), a microprocessor, a microcontroller, etc. of the first device 600, which may work with a first communication part and/or component (e.g., the NFC chip 113, the NFC coil 115, etc.) of the first device 600 to communicate with the second device 800 using the first communication technology (e.g., the NFC communication technology), thereby identifying the identity information of the second device 800.

The pairing relationship establishing module 660 may be used to establish a pairing relationship with the identified second device 800 using a second communication method including a second communication technology, where the second communication technology may have a larger communication range than the first communication technology. The pairing relationship establishing module 660 may be a Central Processing Unit (CPU), a Digital Signal Processor (DSP), a microprocessor, a microcontroller, etc. of the first device 600, which may work with a second communication part and/or component (e.g., a Bluetooth module, etc.) of the first device 600 to communicate with the second device 800 using the second communication technology (e.g., the Bluetooth communication technology), thereby establishing a communication connection with the second device 800 to perform the transmission of data and/or control commands.

In addition, the first device 600 may further include, for example, an operation interface triggering module, which may be used to automatically trigger the opening of the operation interface on the second device 800 after the first device 600 establishes a pairing relationship with the second device 800.

In addition, the first device 600 may also include other functional components not shown in FIG. 6, however, since these components may not affect those skilled in the art to understand the embodiments of the present disclosure, they are omitted in FIG. 6. For example, the first device 600 may also include one or more of the following: a power source, a memory, a data bus, an antenna, a wireless transceiver, and the like.

The method for automatic pairing 500 performed at the first device 600 and the first device 600 will be described below with reference to FIG. 5 and FIG. 6 according to embodiments of the present disclosure.

The method 500 starts in step S510, in which the second device 800 may be identified by the device identification module 650 of the first device 600 using the first communication technology.

In step S520, the pairing relationship establishing module 660 of the first device 600 may establish a pairing relationship with the identified second device 800 using the second communication technology, where the second communication technology may have a larger communication range than the first communication technology.

In some embodiments, the first communication technology may be an NFC or a RFID communication technology, and the second communication technology may be a Bluetooth or a Wi-Fi communication technology. Further, in some embodiments, the first device 600 may be a mobile terminal gimbal, and the second device 800 may be a mobile terminal. Furthermore, in some embodiments, prior to step S510, the method 500 may further include: bringing the second device 800 to be relatively close to the first device 600, to be within a communication range of the first communication technology. In some embodiments, bringing the second device 800 relatively close to the first device 600 may include fixing the second device 800 to the first device 600 by the mobile phone fixture 110 on the first device 600. In some embodiments, the mobile phone fixture 110 may be a clamping structure. In some embodiments, the communication component of the first communication technology may be included in the mobile phone fixture 110. In some embodiments, the communication component may include at least the NFC chip 113 and the NFC coil 115. In some embodiments, after step S520, the method 500 may further include controlling the second device 800 via the first device 600.

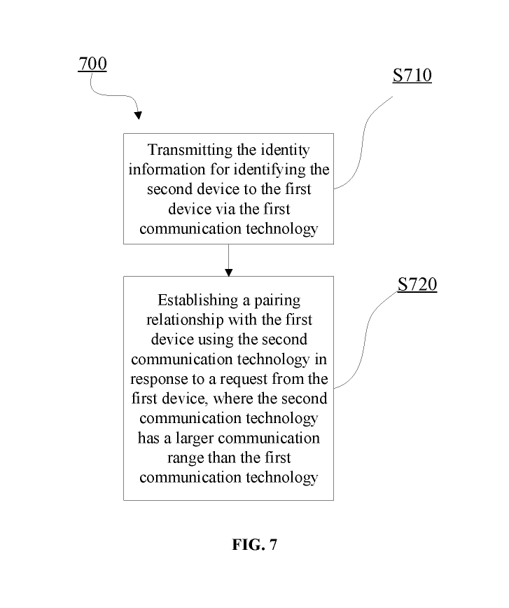

FIG. 7 is a flowchart illustrating a method for automatic pairing 700 with the first device 600 performed in the second device 800 according to an embodiment of the present disclosure. As shown in FIG. 7, the method 700 may include steps S710 and S720. In accordance with the present disclosure, some of the steps of method 700 may be performed separately or in combination, and may be performed in parallel or sequentially, and is not limited to the specific order of operations illustrated in FIG. 7. In some embodiments, the method 700 may be performed by the second device (the mobile phone) 800 shown in FIG. 3.

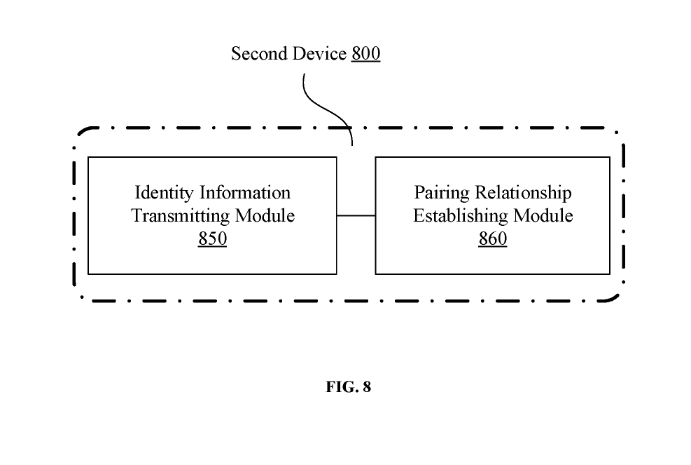

FIG. 8 is a functional block diagram illustrating an exemplary second device 800 for automatic pairing according to an embodiment of the present disclosure. As shown in FIG. 8, the second device 800 may include an identification information transmitting module 850 and a pairing relationship establishing module 860.

The identification information transmitting module 850 may be used to transmit the identification information used to identify the second device 800 to the first device 600 through the first communication technology. The identification information transmitting module 850 may be a Central Processing Unit (CPU), a Digital Signal Processor (DSP), a microprocessor, a microcontroller, etc. of the second device 800, which may work with a first communication part and/or component (e.g., the NFC chip 113, etc.) of the second device 800 to communication with the first device 600 using the first communication technology (e.g., the NFC communication technology), thereby transmitting its identify information to the first device 600.

The pairing relationship establishing module 860 may be used to establish a pairing relationship with the first device 600 using the second communication technology in response to a request from the first device 600, where the second communication technology may have a larger communication range than the first communication technology. The pairing relationship establishing module 860 may be a Central Processing Unit (CPU), a Digital Signal Processor (DSP), a microprocessor, a microcontroller, etc. of the second device 800, which may work with a second communication part and/or component (e.g., a Bluetooth module, etc.) of the second device 800 to communicate with the first device 600 using the second communication technology (e.g., the Bluetooth communication technology), thereby establishing a pairing relationship with the first device 600 using the second communication technology in response to the request from the first device 600.

In addition, the second device 800 may further include an operation interface control module that may be used to automatically open an operation interface on the second device 800 after establishing a pairing relationship with the first device 600.

In addition, the second device 800 may also include other functional components not shown in FIG. 8, however, since these components may not affect those skilled in the art to understand the embodiments of the present disclosure, they are omitted in FIG. 8. For example, the second device 800 may also include one or more of the following: a power source, a memory, a data bus, an antenna, a wireless transceiver, and the like.

The method for automatic pairing 700 performed at the second device 800 and the second device 800 will be described below with reference to FIG. 7 and FIG. 8 according to embodiments of the present disclosure.

The method 700 starts in step S710, in which the identification information transmitting module 850 of the second device 800 may transmit the identification information for identifying the second device 800 to the first device 600 via the first communication technology.

In step S720, the pairing relationship establishing module 860 of the second device 800 may establish a pairing relationship with the first device 600 using the second communication technology in response to a request from the first device 600, where the second communication technology may have a larger communication range than the first communication technology.

In some embodiments, the first communication technology may be an NFC or a RFID communication technology, and the second communication technology may be a Bluetooth or a Wi-Fi communication technology. Further, in some embodiments, the first device 600 may be a mobile terminal gimbal, and the second device 800 may be a mobile terminal. Furthermore, in some embodiments, prior to step S710, the method 700 may further include: bringing the second device 800 to be relatively close to the first device 600, to be within a communication range of the first communication technology. In some embodiments, bringing the second device 800 relatively close to the first device 600 may include fixing the second device 800 to the first device 600 by the mobile phone fixture 110 on the first device 600. In some embodiments, the mobile phone fixture 110 may be a clamping structure. In some embodiments, the communication component of the first communication technology may be included in the mobile phone fixture 110. In some embodiments, the communication component may include at least the NFC chip 113 and the NFC coil 115. In some embodiments, after step S720, the method 700 may further include controlling the second device 800 via the first device 600.

As such, the disclosed method and device may allow a mobile terminal (e.g., a mobile phone) and a gimbal to establish a wired or wireless connection to improve the current process by adding a pairing chip (e.g., an NFC chip) on the handheld gimbal and identifying the mobile terminal by the pairing chip, then establishing the connection quickly via Bluetooth, and then automatically opening the application to start capturing images after the connection is established. The method and device provided in the present disclosure provide a quick, convenient, and stable connection as it simplifies the connection process so a user is only required to place the mobile terminal on the gimbal to complete the automatic pairing and start capturing images, thereby greatly improving the operation of the handheld gimbal and the user experience.

While the present disclosure has been shown and described with reference to certain exemplary embodiments thereof, it should be understood by those skilled in the art that various changes in form and detail may be made therein without departing from the spirit and scope of the present disclosure.

In addition, functions described herein as being implemented by only hardware, only software and/or firmware can also be implemented by means of dedicated hardware, a combination of general purpose hardware and software, etc. For example, functions described as being implemented by dedicated hardware (for example, a Field Programmable Gate Array (FPGA), an ASIC, etc.) can be implemented by general purpose hardware (for example, a CPU, a DSP) in combination with hardware such as an analog-to-digital conversion circuit, an amplifier circuit, an antenna, and Bluetooth and NFC related processing software, and vice versa.

Other embodiments of the present disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method for an automatic pairing of a first device with a second device, comprising:
identifying the second device using a first communication method; and
establishing a pairing relationship with the identified second device using a second communication method, wherein the second communication method has a larger communication range than the first communication method.

2. The method of claim 1, wherein:
the first communication method is a near field communication (NFC) or a radio frequency identification communication (RFID) technology, and
the second communication method is a Bluetooth or a Wi-Fi communication method.

3. The method of claim 1, wherein:
the first device is a carrier, and
the second device is a load being carried on the first device.

4. The method of claim 1, wherein identifying the second device using the first communication method further includes:
having a distance between the second device and the first device within a communication range of the first communication method during the identifying process.

5. The method of claim 4, wherein having the distance between the second device and the first device within the communication range of the first communication method is implemented by:
using a fixing structure on the first device to fix the second device to the first device.

6. The method of claim 5, wherein a communication component used for the first communication method is disposed on the fixing structure.

7. The method of claim 1, wherein after establishing the pairing relationship with the identified second device using the second communication method, the method further includes:
controlling the second device via the first device.

8. The method of claim 1, wherein establishing the pairing relationship with the identified second device using the second communication method further includes:
acquiring an identified identity information of the second device by the first device; and
establishing the pairing relationship with the second device using the second communication method based on the identity information.

9. The method of claim 8, further including:
automatically triggering an opening of an operation interface on the second device after the first device establishes the pairing relationship with the second device.

10. A first device for automatically pairing with a second device, the first device comprising:
a first communication component configured for a first communication method;
a second communication component configured for a second communication method; and
a processor, configured to perform:
identifying the second device via the first communication component using the first communication method; and
establishing a pairing relationship with the identified second device using the second communication method via the second communication component, wherein the second communication method has a larger communication range than the first communication method.

11. The device of claim 10, wherein:
the first communication method is a near field communication (NFC) or a radio frequency identification communication (RFID) technology, and
the second communication method is a Bluetooth or a Wi-Fi communication method.

12. The device of claim 10, wherein:
the first device is a carrier, and
the second device is a load carried on the first device.

13. The device of claim 10, wherein a distance between the second device and the first device is within a communication range of the first communication method, when identifying the second device via the first communication component using the first communication method.

14. The device of claim 13, wherein the second device is fixed to the first device by a fixing structure on the first device.

15. The device of claim 14, wherein the first communication component is disposed on the fixing structure.

16. The device of claim 10, wherein the processor is configured for allowing the first device to control the second device.

17. The device of claim 10, wherein the process is further configured for:
acquiring an identified identity information of the second device, and
establishing the pairing relationship with the second device using the second communication method based on the identity information.

18. The device of claim 17, wherein the process is further configured for:
automatically triggering an opening of an operation interface on the second device after the first device establishes the pairing relationship with the second device.

19. The device of claim 10, wherein:
the first device is a handheld gimbal configured for carrying an information acquisition device, and
a device identification module is disposed on the first device.

20. The device of claim 10, wherein the first device is configured for communicating with a portable electronic device.
